(19) United States
(12) Patent Application Publication
(10) Pub. No.: US 2014/0081880 A1
(43) Pub. Date: Mar. 20, 2014

(54) CONTENT MANAGEMENT SYSTEM AND METHOD

(71) Applicants: Joseph C. Estes, JR., Chino Hills, CA (US); Joaquin Brown, Culver City, CA (US); Dave B. McLelland, Laguna Niguel, CA (US); DeAnna Carels, Laguna Beach, CA (US); Chris Turner, Orange, CA (US); Lyndsie Lee Olson, Anaheim Hills, CA (US)

(72) Inventors: Joseph C. Estes, JR., Chino Hills, CA (US); Joaquin Brown, Culver City, CA (US); Dave B. McLelland, Laguna Niguel, CA (US); DeAnna Carels, Laguna Beach, CA (US); Chris Turner, Orange, CA (US); Lyndsie Lee Olson, Anaheim Hills, CA (US)

(21) Appl. No.: 13/621,208

(22) Filed: Sep. 15, 2012

(51) Int. Cl. G06Q 99/00

(52) U.S. Cl. 705/319

(57) ABSTRACT

A content management system disclosed communicates between commercial participants and social media participants connected by a social media network including a location-centric system that tracks store locations of its commercial participants relative to a location of one or more mobile communication devices of one or more portions of social media participants. A product and service licensing center categorizes the commercial participants in accordance with a level of economic benefit participation in relationship to the location of the one or more mobile communication devices of the social media participants. The level of economic benefit participation provided by its commercial participants determines a scaled commercial relationship between marketing of the commercial participants to the one or more mobile communication devices of the social media participants

### PRIORITY AND RELATED APPLICATION(S)

This U.S. non-provisional utility patent application is co-pending with and claims priority to and incorporates by reference in its entirety US non-provisional utility non-provisional patent application entitled “WIRELESS MODILE COMMUNICATION SYSTEM REWARDS ROYALITY SYSTEM AND METHOD” Ser. No. 12/477,117 filed on May 22, 2012; claims priority to, and incorporates by reference in its entirety US non-provisional utility patent application entitled “LOCATION DETERMINATION SYSTEM AND METHOD USING ARRAY ELEMENTS FOR LOCATION TRACKING” Ser. No. 13/349,565, filed on Jan. 13, 2012, incorporates by reference in its entirety US non-provisional utility patent application entitled “SIGNAL RESET CIRCUIT FOR WIRELESS COMMUNUCATION SYSTEMS” Ser. No. 13/349,561 filed on Jan. 13, 2012; claims priority to and incorporates by reference in its entirety U.S. non-provisional application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 filed on Dec. 4, 2011, claims priority to and incorporates by reference in its entirety co-pending U.S. Utility patent application Ser. No. 13/010,437 filed on Jan. 20, 2011; and claims priority to and incorporates by reference in its entirety co-pending U.S. Utility patent application Ser. No. 12/831,471 filed on May 22, 2012, and is co-pending with and claims priority to “SOCIAL MEDIA PARTICIPANT ECONOMIC BENEFIT SYSTEM AND METHOD” Ser. No. ______ having the same inventors as this application and filed concurrently with this application.

### BACKGROUND

1. Field of the Disclosure

This disclosure relates generally to the field of social media networks, and specifically in one exemplary aspect to a content management system for a social media system and method employing profiles and associations of its participants to improve communications, advertisements and marketing efforts in a location centric manner by commercial participants of products and services.

2. Description of Related Technology

Social media networks are very fast growing and popular among a growing sector of the population. Social media networks help others stay in touch with friends, family and make many other social relationships that would not otherwise be possible. For instance on a global scale through social media networks, others can interact and play computer games between individuals in cities or even countries that are thousands of miles apart and share culture and likes and dislikes. Participants can meet others in a safe setting, and test the water so as to evaluate a type and level of interaction that is best on an individual basis and on a group level. Through social media networks, the sharing of ideas and concepts is ramped up. The concept of sharing information and “going viral” is made possible by many video posting websites, e.g. You Tube. In yet another example, participants may post what's happening in their lives on social medial network pages, including Facebook and Twitter. As such, participants feel free to express themselves and help others at the same time.

However, there are still other possibilities for improvements on social media networks processes and apparatuses that permit further sharing of information, i.e., provide marketing processes and provide a forum to test and adapt learning or modeling algorithms, to improve real-time sharing and help others with their daily lives, which minimizes the required labor and/or time from initially obtaining information to the processing and subsequent sharing or posting of these ideas. Such improved apparatus and methods would ideally minimize labor-intensive tasks of Internet postings and be part of an automatic or semi-automatic algorithm and structure.

### SUMMARY

In one aspect, a content management system is disclosed that communicates between commercial participants and social media participants connected by a social media network. A location-centric system is disclosed that encompasses a location tracking system and other systems that are location focused both inside a building or area and outside tracks store locations of its commercial participants relative to a location of one or more portions of social media participants. A product and service licensing center categorizes the commercial participants in accordance with a level of economic benefit participation in relationship to the location of the social media participants. The level of economic benefit participation provided by its commercial participants determines a scaled commercial relationship between marketing of the commercial participants to the social media participants.

In yet another aspect, a method is disclosed for communicating between commercial participants and social media participants connected by a social media network. The method includes tracking by a location-centric system store locations of its commercial participants relative to a location of, e.g., one or more mobile communication devices, of one or more portions of social media participants, categorizing by a product and service licensing center of the commercial participants in accordance with a level of economic benefit participation in relationship to the location of the social media participants, and determining a level of economic benefit participation of its commercial participants based on a scaled commercial relationship between marketing of the commercial participants to the social media participants.

These and other embodiments, aspects, advantages, and features of the present disclosure will be set forth in part in the description which follows, and in part will become apparent to those skilled in the art by reference to the following description of the disclosure and referenced drawings or by practice of the disclosure. The aspects, advantages, and features of the disclosure are realized and attained by means of the instrumentalities, procedures, and combinations particularly pointed out in the appended claims.

### BRIEF DESCRIPTION OF THE DRAWINGS

FIG. 1 illustrates a content management system in accordance with an embodiment of the present disclosure;

FIG. 2 illustrates social media participants that are outside and inside members of a social media exchange center that includes a collection of social media participant village networks and commercial participants of village network(s) having different levels of exposure or involvement in the content management system;

FIG. 3 illustrates commercial participants having different levels of economic benefit participation including level of advertisement that is compatible with levels of licensing payment;

FIGS. 4 and 5 illustrates exemplary systems using a Bluetooth module, a Wi-Fi module, an ultrasound controller, sound transceiver units, a phased array module and/or other data or location tags including data tags, e.g., ID tags, for distancing objects and obtaining information about social media network(s) including social media participants and commercial participants, e.g., both inside and outside of a village network, within a room or location in accordance with the present application; and

FIG. 6 illustrates a flow diagram of content management system in accordance with an embodiment of the present disclosure.

### DETAILED DESCRIPTION

Reference is now made to the drawings wherein like numerals refer to like parts throughout.

### Overview

In one salient aspect, the present disclosure discloses apparatuses and methods for assisting others in consumer purchases, likes or consumer transactions related to, inter alia, commercial participants', e.g., commercial participants', e.g., retailers, marketing, advertisement, promotional and brand development campaigns and the electronic messages, likes, and other information transfers. In particular, the present disclosure discloses an apparatus and method configurable to assist a social media participant, e.g., consumer, and/or a retailer product or service center, e.g., commercial participant, in evaluating a method for initiating, generating and delivering information transfers, for example, which attract and maintain consumers and relationships thereof. Furthermore, the present disclosure further discloses a technique for accurately portraying in real-time, likes associated with positive feeling transactions identified, such as recently purchased items while collecting empirical data associated with groups of participants in a convenient database or persistent store, with selected profiles or categorical information highlighted or displayed or assessable in a non-distracting manner.

Furthermore, the present system advantageous provides an improved process or system to provide multiple configurations, and thus permit the creation of user-personalized, e.g., customized, sharing configurations using one or more structures or components and software routines. In addition, the improved process or system disclosed subsequently will assist in informing others on a global scale of commercial participants products and services and thereby potentially reduce a number or magnitude thereof of returns by consumers, frustration by consumers with multiple products and services that cover the same or similar issues, and as such, provide a consumer a more informed, direct, and information and market centric system for sharing information over a social media network and perhaps provide one or more rewards to participants for their efforts. In addition, the improved process or system would assist commercial participants of products and services better utilized resources so as to potentially improve market share and brand value.

In addition, the apparatus advantageously allows a more intuitive method to view likes associated with consumer transactions in real-time situations where other reviews and operations management or advertisement methodologies may not detect these commercial participants' products or services in a centric location fashion until months after a consumer transaction has been completed. For instance, with this invention, not only can a user with a real-time generated referral report and discover proximal location for future transactions but he/she also can distinguish physical and empirical characteristics of the transactions, e.g., location of the transaction, type of merchant, frequency of the transaction, amount of spending at a particular establishment and relate this a consumers profile or categories of commercial participants. Furthermore, commercial participants, e.g. retailers, can provide a user, e.g., social media participant or commercial participant, with a location-centric experience, e.g., information, and other economic benefit(s). The content management system (CMS) and methodology involves how do the network of villages, e.g., social media participant villages 200, 300, and retailer villages 400, 500, associate and transfer location-centric information between and among themselves. As such, the systems and methods of the villages allows user's a more intuitively distinguish signals of future consumer details, even before one or more transactions occur or are contemplated by a consumer. In addition, the apparatus advantageously provides the ability to preserve database information from different sources and attaches and adjusts indicators and details of transactions into a more natural format and generate consumer reports thereof.

Advantageously, in one embodiment, the detection of consumer transactions when purchasing from commercial participants that are of a different type or kind thereof from that of the historical transactions. Advantageously, in one embodiment, the system improves a user's ability, e.g., social media participants, commercial participants, or the like, to distinguish transactions and other features that could not otherwise be seen using conventional software or apparatus. In particular, the present disclosure discloses an apparatus and method configurable to assist social media participant, e.g., consumer, user of a mobile communication device, and commercial participant, e.g., retailer of products and services, a business or company engaged in distribution, sales of consumer products and services, a business engaged in advertisements of consumer and retail products and services for a profit, product or service center. In one example, commercial participant evaluates a method for initiating and generating advertisements that communicate new products or services. In another example, commercial participants understand when a social media participant, e.g., user, is outside a commercial participants' location, e.g., using location tracking software including global positioning systems (GPS), or is inside a retailer's village so that a user can associate themselves with those consumer goods or service plans, e.g., cellular phone services, grocery purchases, or the like, that represent themselves.

As such, the location-centric location system allows a user to plan anniversaries, birthdays, and other occasions and to post pictures, comments, likes, dislikes, that a person wants, e.g. wish lists, and user wants as a reminder of what they should buy as a gifts. These are then published on a user's profile for consumption by other social media participants. As such, the one or more routines disclosed of one embodiment unobtrusively highlight a potential for improved consumer transaction information availability for agencies to utilize in evaluating likelihood of successful consumer transactions. Furthermore, in one or more embodiments, consumer participants understand when one or more social media participants, e.g., users, are outside of consumer participants' store or purchase through agencies, e.g., distributers, and to manage and update one or more particulars of villages, either automatically or semi-automatically. In one variant, social media participants and commercial participants provide an opportunity to manage their reward points from all stores, brands, for example, in one location, e.g., wedding register.

As used herein, the term “wireless” refers to wireless communication to a device or between multiple devices. Wireless devices may be anchored to a location and/or hardwired to a power system, depending on the needs of the business, venue, event or museum. In one embodiment, wireless devices may be enabled to connect to Internet, but do not need to transfer data to and from Internet in order to communicate within a wireless information communication and delivery system;

In addition and as used herein, the term “Smart Phone(s)” or “smart phone(s)” or “mobile communication device(s)” refers to a wireless communication device(s), that includes, but not is limited to, an integrated circuit (IC), chip set, chip, system-on-a-chip including low noise amplifier, power amplifier, Application Specific Integrated Circuit (ASIC), digital integrated circuits, a transceiver, receiver, or transmitter, dynamic, static or non-transitory memory device(s), one or more computer processor(s) to process received and transmitted signals, for example, to and from the Internet, other wireless devices, and to provide communication within the wireless information communication and delivery system including send, broadcast, and receive information, signal data, location data, RSSI (Relative Signal Strength Indicator), one or more indications of signal strength to data tags, e.g., identification tags or ID tags, within an area or room that communicate between mobile communication device(s) and one or more information repositories, for instance, including information servers including information about commercial participants' products or services, a bus line, an antenna to transmit and receive signals, and power supply such as a rechargeable battery or power storage unit. The chip or IC may be constructed (“fabricated”) on a “die” cut from, for example, a Silicon, Sapphire, Indium Phosphide, or Gallium Arsenide wafer. The IC may be, for example, analogue or digital on a chip or hybrid combination thereof. Furthermore, digital integrated circuits may contain anything from one to thousands or millions of signal invertors, and logic gates, e.g., “and”, “or”, “nand” and “nor gates”, flip-flops, multiplexors, etc., on a square area that occupies only a few millimeters. The small size of, for instance, IC's allows these circuits to provide high speed operation, low power dissipation, and reduced manufacturing cost compared with more complicated board-level integration;

As used herein, the term “location information” refers without limitation to any set or partial set of integer, real and/or complex location data or information such as longitudinal, latitudinal, and elevational positional coordinates, x, y, and z coordinates within a location or relative location coordinates to one or more objects, Wi-Fi networks, and wireless communication devices;

As used herein, the terms “wireless data transfer,” “wireless tracking and location system,” “positioning system” and “wireless positioning system” refer without limitation to any wireless system that transfers data or communicates or broadcasts a message, which communication may include location coordinates or information, e.g., user profile, advertisements transferring using one or more devices, e.g., wireless communication devices; and

As used herein, the terms “module” or “modules” refer without limitation to any software, firmware, or actual hardware or combination thereof that has been added on, downloaded, updated, transferred or originally part of a larger computation or transceiver system that assists in or provides computational ability including, but not limited to, logic functionality to assist in or provide communication broadcasts of commands or messages, which communication may include location coordinates or information, e.g., user profile, advertisements that transfer between, among, or to one or more devices, e.g., wireless communication devices.

### Exemplary Apparatus, System, and Method

Exemplary embodiments of the apparatus, system, and methods of the invention are described in detail. It will be appreciated that while described primarily in the context of a content management system and apparatus, there are at least portions of the apparatus and other methodology for configuring the apparatus, system, and methodology described herein that may be used for other applications or purposes.

For example, it will be recognized that the present disclosure may be used to create consumer transactions models and commercial participants' products or services coding charts that indicate history and probability of future purchases or likes. In addition, the present disclosure may be used to enable commercial participants to determine the level of staffing required in their store(s) or location(s). Other functionality or applications of the present invention may include assistance in clearance processing of retail and commercial application(s), determination of type and line of credit to provide a prospective consumer, security monitoring of present consumer transactions, consumer specific application processing and clearance processing, and the like. As such, a myriad other functions will be recognized by those of ordinary skill given the present disclosure.

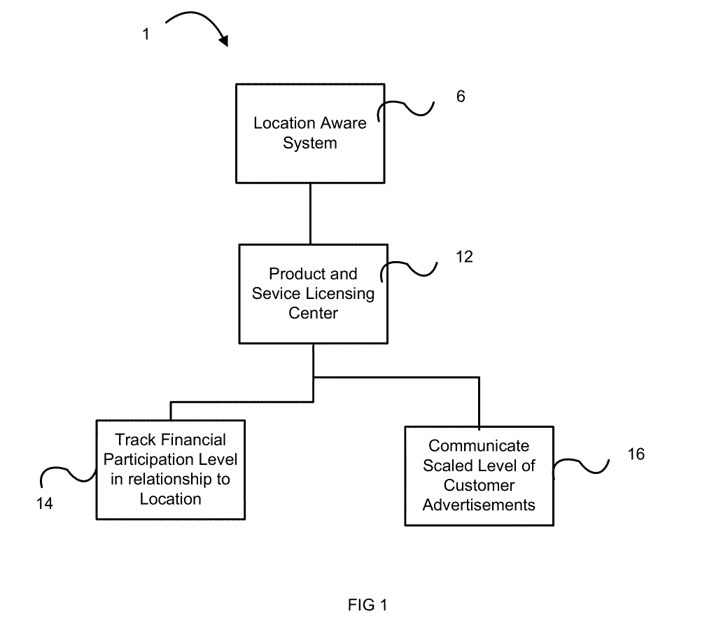

Referring to FIG. 1, a content management system 1 is disclosed that communicates between commercial participants and social media participants connected by a social media network. In this system, location aware system 6 understands, e.g., tracks, the store locations of its commercial participants relative to a location of one or more portions of social media participants. Product and service licensing center 14 categorizes the commercial participants in accordance with a level of economic benefit participation, e.g., financial benefit for leads or tips, in relationship to the location of the social media participants. In one example, the level of economic benefit participation provided by its commercial participants determines a scaled commercial relationship, e.g., marketing relationship, between the commercial participants to the social media participants based on, for example, product or service marketing campaigns. In one example, the location includes a present, future, or pending location that includes proximity of a portion of the commercial participants based on the scaled commercial relationship to a portion of the social media participants.

In yet another example, the scaled commercial relationship includes a scaled level of personalized information transfers communicated via the social media network. In still another example, scaled level of personalized information transfers include a range from an address and phone to a personalized audio and video presentation and other forms of media transfer generated based on a user profile including likes of one or more portions of the social media participants within a designated location or range of a commercial participants' product or service center. In one alternative, the level of economic benefit participation includes whether commercial participants have or have not paid for a license to utilize the content management system, and the level of license a commercial participant obtained. In yet another alternative, location-centric system includes data tags, e.g., ID tags, that locate social media participants based on location of mobile communication device, for example associated with, and based on the location centric information enable a range or level of information, e.g., information, transfers that is comparable with a level of licensing payment.

### Content Management System (CMS)

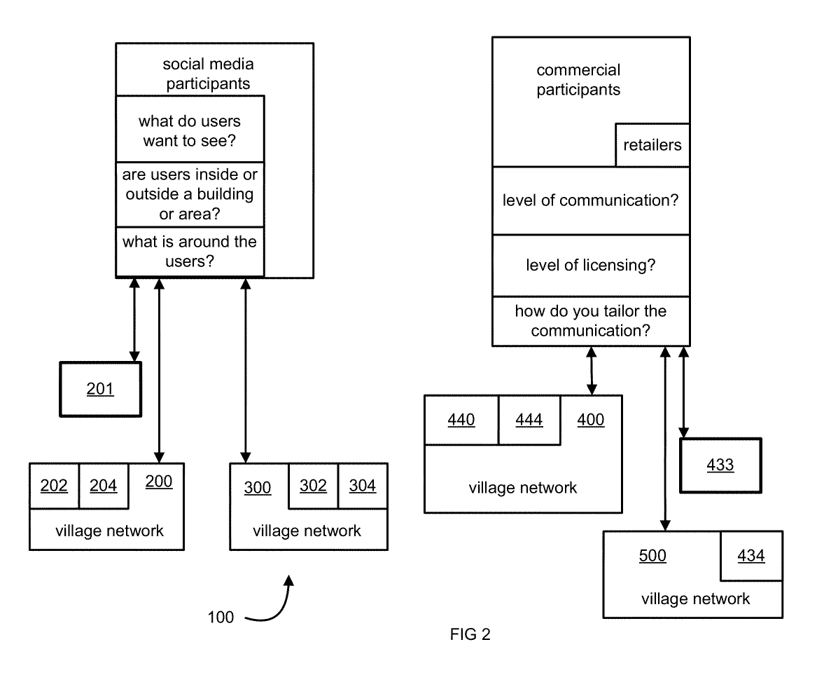

Referring to FIG. 2, a first exemplary example of system 100 is illustrated below. The content management system (CMS) includes CMS module that communicates between social media participants including individuals, e.g., social media participant 201, ones that have joined one or more village networks, e.g., 200, 300, and different levels of commercial participants, e.g. retailers, from village networks 400, 500 using, for instance, location tracking methodologies disclosed in incorporated by reference applications listed above. For example, using the CMS system, commercial participants, e.g., retailers, and their villages have different levels of exposure and access to social media participants and village networks of social media participants.

In one exemplary aspect to illustrate the different levels of exposure and access, some commercial participants, e.g., retailers, have minimal content exposure to social media participants which are referred as global social media network, e.g., BigView social media network. After downloading the CMS module, e.g., software, BigView commercial participants, e.g. retailers, provide social media participant(s) an opportunity to view multiple venues, e.g., multiple commercial participants products and services, and other features of the software application, e.g., uploaded pictures or commentary by other social media participant(s). While viewing multiple venues and features, the content management system is building the customer database based on preferences and likes, e.g., based on product or service preferences, stored likes, current or past location, or the like, of the social media participant.

In one example, the customer database is loaded into village network of one or more social media participants; thus, new or additional businesses or services may be added to one or more village networks that are not currently part of the CMS module. Advantageous, this addition of new businesses and services to one or more village network(s) allows social media participants, for instance, that outside or inside of a village network to start creating a commercial relationship with a database of products or services for different locations that they don't currently have a commercial relationship. As such, CMS module provides an ability to create a location aware system that allows social media participants to write and upload review(s) for products or services relative to different locations to various products or services.

In one variant, social media participants upload pictures of products and services to create a personal database that becomes part of their social media network, e.g., village network, within the CMS module. For instance, the personal database may indicate products and services for a particular location. Advantageously, social media participants may take notes based on location of products and services. For example, social media participants may be shopping in a department store and want to remember a name of a particular brand or a style of slacks or dress shirt. By logging in personal notes section for a particular location, social media participant may later share it with a friend, post pictures of the items in a notepad or the social media participant's village network.

As such, social media participants may search out locations that carry the products or services that they need including brands of products or services currently on a wish list or part a current search. In addition, social media participants may write reviews for different locations as well as products or services at the different locations and see written reviews by others on one or more different locations as well as products or services.

On the other hand, other commercial participants may opt for social media network having a greater level of access and exposure to social media participants than in BigView social media network. This greater level of access and exposure to social media participants enables commercial participants to advertise, market or sell goods or services, and to otherwise provide information transfers to social media participants, for example, without active data tags, which are referred as local social media network, e.g. PreView social media network. For example, PreView commercial participants provide additional information transfers to social media participants about a location of products or services, but not information about products or services specific or particular to a location of products or services. For example, the additional information may include quantity or quality aspects of one or more groups of products or services available at this location, availability, number or quantity of a specified category of products or services, or the like. In addition, PreView commercial participants may provide information transfers on additional or ancillary items associated with the locations specific products or services.

And still other commercial participants may opt for a still greater level of access and exposure to social media participants than PreView social media network provides. This greater level of access and exposure to social media participants enables commercial participants to advertise, market or sell products, e.g., goods, or services, and to otherwise provide information transfers to social media participants, for example, having active data tags, e.g., ID tags, as discussed in the applications incorporated by reference in its entirety, in the commercial participants store(s) or location(s) which are referred as inside social media network, e.g. InView social media network. For example, InView commercial participants may provide information transfers including specifics such as, for example, branding messages, coupons, other economic benefits, unit price, warranties (if available), user postings, product lifetime, and efficient usage of a product or service.

In one variant, a level or classification of the commercial participants, e.g. retailers, access and exposure to social media participants of BigView social media network, PreView social media network or InView social media network, the “level of participation” will determine which and ordering of commercial participants, e.g. retailers, who will be accessible by social media participants. For example, depending on level of participation, commercial participants, e.g. retailers, will only see or be able to interact with select categories of social media participants, for example, categorized by one or more likes into one or more social media categories, e.g., best friends, friends, social acquaintances, wish lists, style, music, film, collectors, girlfriend(s), social partners, concerts, wine, food, and business acquaintances, and the like.

Based on the categories, each of the social media participants may be categories in village network, a group of social medial participants with common social media categories based on one or more likes. For instance, village network may include social participants who have similar likes on multiple social media categories. For example, villages networks are organized and setup to personalize and social users' experiences, for instance, in accordance with brand selection, e.g., preferred brand. In one variant, social media categories are customizable into favorites in accordance with likes and preferences of a social media participant. In another example, social media participants are able to rate products or places. In still another variant, social media participants have an ability to share portions of village network, e.g., written reviews for purchase of products or services based on location, on other social media platforms, e.g., Facebook, Twitter, Pinterest, or the like.

In still another variant, social media participants have an ability to share portions of village network, e.g., product-based reminders, location-based reminders, and stories, related to friends or family members for purchase of products or services based on location, on other social media platforms, e.g., Facebook, Twitter, Pinterest, or the like. For example, a product-based reminder includes “I'm shopping with my wife and I can tell she loves the Gucci purse and wallet, e.g., product, in Macy's. Her birthday is coming up, so I can tell we can't afford it, e.g., an excuse.” By identifying the product to the content management system module, a reminder is created. Whenever I'm near the product again, I'll be reminded of it by an electronic message, e.g., text message, email, a notification within the module or the like. In a location-based reminder includes “I'm home and notice that I'm almost out of dog food, I open the content management system module, and scan in the UPC code of a bag of dog food.” The CMS module knows the item and where it is located. Whenever I'm near a pet store, CMS module will remind me that I need dog food. I have options, for example, to dismiss the message and delete the reminder. The same example could apply to a bottle of wine that you loved at a restaurant, where the CMS module notifies you, e.g., by electronic message, when you are near a retailer who carries that product.

In another example of the CMS module, when one member of the social media participants, for example, in village network views an electronic message that a commercial participant's item that another social media participant has, for instance, in his/her wish list, then such electronic message or the information transfer relative to such electronic message or the item and the location(s) of the commercial participant where the item may be found near the other social media participant is stored or communicated so that the CMS module knows that such electronic message and the information transfer applies to the other social media participant and/or so that an economic benefit may be provided to either social media participant and/or the commercial participant. Afterwards, an electronic message is generated, based on inputs from other social media participants and referral social media participants shared profile items, and sent to the other social media participant to notify them, for example, who sent them the referral and any commercial participants' specials for this item at a participating commercial participant in the social media participant's current and/or home location.

In addition, an electronic message may be delivered by push notification to social media participants based on the mobile operating system in the mobile device used by the social media participant. In another example, when the other social media participant's location is proximal to the item, then a reminder electronic message may be sent to the other social media participant reminding such social media participant about any prior interest in this item. When the electronic message is viewed by the other social media participant either by mobile communication, on-line, or in person at the store based on location, a first economic benefit reward is deposited into a recommender's account or otherwise credited to the recommender. Upon purchase at a location in accordance with a level of commercial participants, e.g., retailers, a second economic benefit reward is deposited into the recommender's account or otherwise credited to the recommender.

Advantageously, the CMS module provides a web-based system for mobile communication device, e.g., smart phone, social media participants relevant information based on what's in a proximity and/or immediate proximity of social media participants. In yet another advantage, the CMS module provides, in a retail environment, information about products and services in a particular store or center, e.g., which is closest to a social media participant. Commercial participants, e.g. retailers, communicate with social media participants, e.g., users, based on the social media participant's specific location either outside or inside, e.g., store, museum, school, transportation hub, venue or the like.

The specific information transfers to be delivered based on a precise location is controlled via CMS module. CMS module manages the specific, e.g., product, information transfers as well as electronic messages.

As such, CMS module provides a tool that enables management of one or multiple venue(s), e.g., commercial participants, retailers, museum school administration, administrator, or the like, to communicate to social media participants, e.g., users, through their mobile communication device. In another example, CMS module times these communications, e.g., create reminders, communicates electronic messages, based on a number of inputs, including a location of social media participant to one or more venues or locations.

Furthermore, CMS application tailors those communications based on a number of factors, e.g., branded venue(s) message(s), accessed content of social media participant(s) uploads of text or pictures. A number of factors may include: what should the social media participants see and know about what is around the social media participant, including but not limited to branding messages, product information, invites, and the like communications, and whether or not a social media participant is part of a village network. In one further example, data tag of commercial participant may indicate to the CMS module which venue or location the social media participant is in or near and where the social medial participant is inside of the venue or location. CMS module provides web-based content to be associated with a location of the venue and or a data tag. Based on a social media participant's location, the CMS module will deliver communications to a mobile communication device of the social media participant based on what is around them through the CMS module.

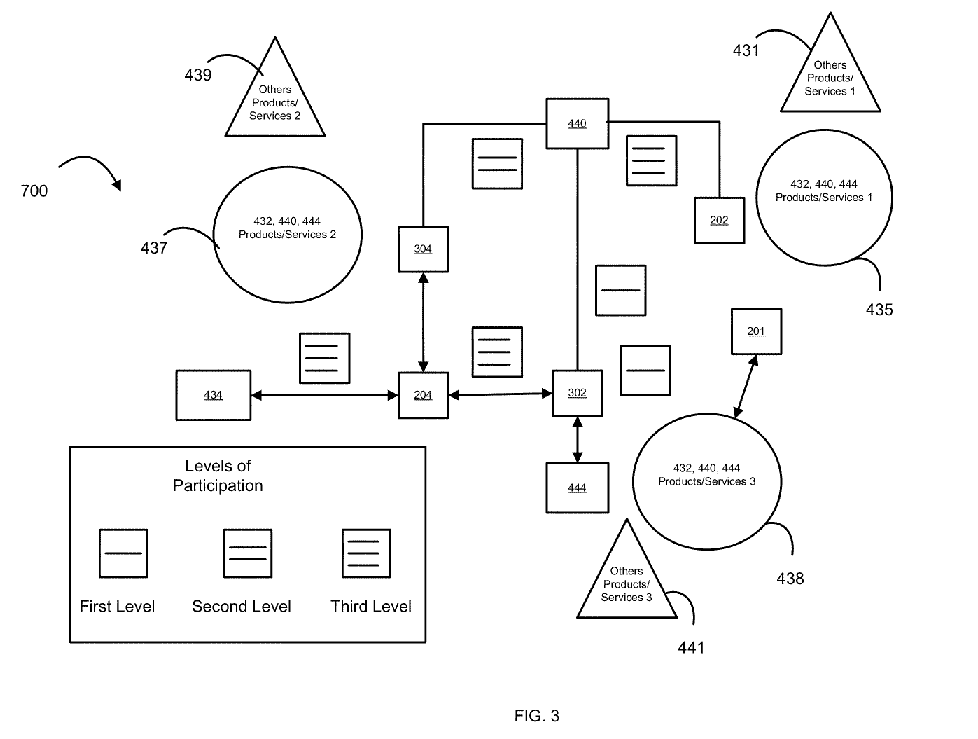

Referring to FIG. 3, with the CMS module, commercial participants, e.g. retailers, 424, 434, 444 are illustrated having different levels of participation, e.g., licensing payments, e.g., first level: 1 horizontal bar indicates BigView commercial participants, e.g. retailers, second level: 2 horizontal bars indicates PreView commercial participants, e.g. retailers, and third level: 3 horizontal bars indicates InView commercial participants, e.g. retailers, and a scaled level of information, e.g., about social media participant profile associated with their mobile communication device including likes or desires, and advertisement that is compatible with level of licensing payment.

For example, commercial participants that are InView commercial participants may view information shared between social media participants based on location, e.g., relative location between social media participants and the items and retailers around them. As such, this level of participation provides an improved confidence level that leads or tips, advertisements, branding messages, and promotions communicated to social media participants meet their desires or requests. Thus, this level of commercial participant may access on-line user profiles to assist in maximizing both current location of the social media participant as related to items, for example, on a wish list, for future purchases. On the other hand, BigView commercial participants may view information on a more limited basis than InView commercial participants, e.g., this level indicates state or general location of social media participant and no user profile information. On the other hand, PreView commercial participants may view additional information than BigView commercial participants e.g., 30 minute time updates where mobile communication device of social media participant near retailer products or services. However, Preview commercial participants still view less than InView commercial participants, for example, receive a profile of a social media participants stored on their mobile communication device.

### Location Aware System Including Levels of Participation of Commercial Participants

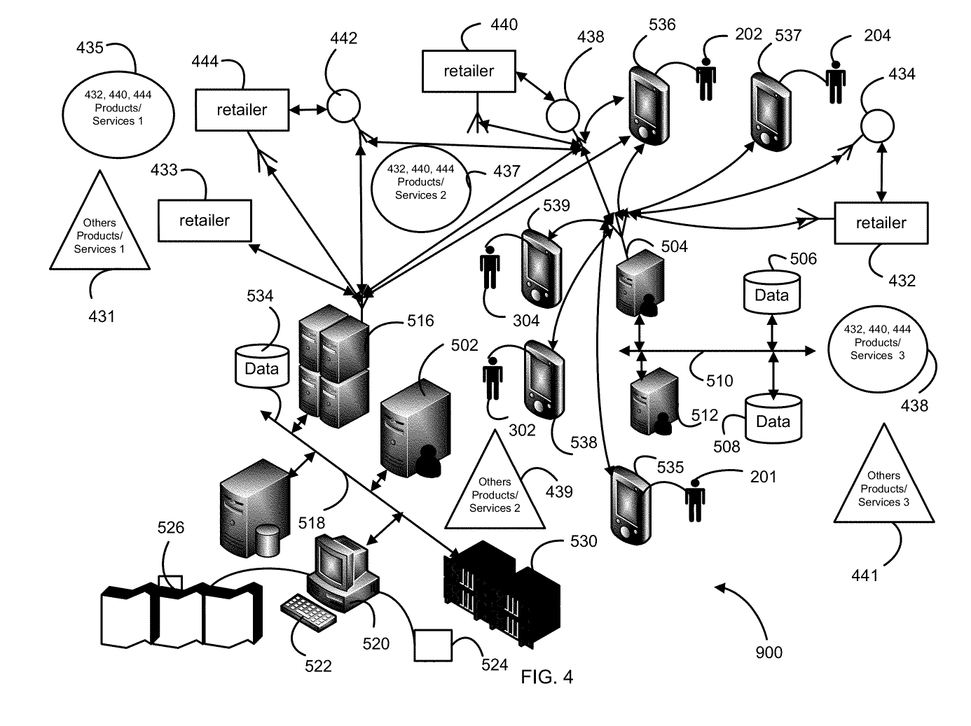

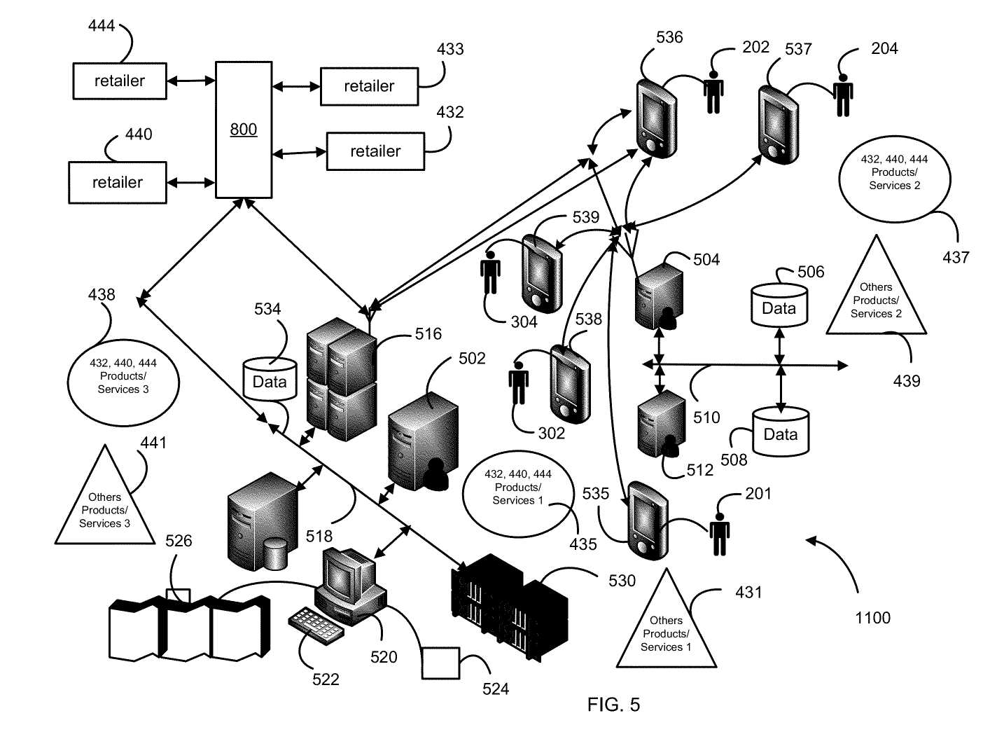

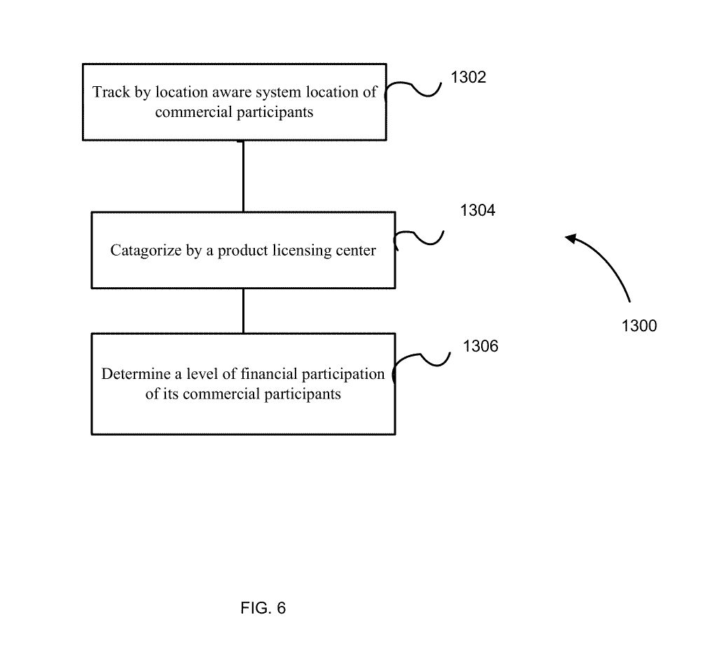

Referring to FIGS. 4 and 5, social media participants' location, e.g., past, current, and future (predicted), is monitored or tracked by using their mobile communication device, e.g., smart phone, location relative to one or more commercial participants, e.g. retailers, locations. For example, future location may be based on past location on at a similar time of the day, e.g., play tennis every Sunday in Brea Calif. next to a local coffee shop that is located near the consumer participant's store. In yet another example, future location may be estimated based on current velocity, for example, moving toward or away from an object or item for sale of a commercial participant.

Exemplary mobile cell phone tracking technologies are disclosed in the above incorporated by reference pending patents applications, which will be discussed supra in this disclosure. Location aware system involves matching of one or more social media participants reviews, postings, and/or user profiles including products and services based on location, e.g., past, current, and future (predicted) and remote management of available tracking technologies to improve accuracy of location tracking data.

As such, location aware system uses location tracking methodologies disclosed in the incorporated by reference and claimed priority to pending patent applications above to determine a location of mobile communication devices of social media participants. In one variant, location aware system determines proximal accuracy, e.g., most repeatable measurements, of a location of each of the social media participants by comparing physical parameters generated by one or more tracking methods included in incorporated by reference patent applications, as relative to a changing or altered location of one or more items.

Exemplary location tracking technologies functionality and location determination for Smart Phone 1, Smart Phone 2, and data tags, e.g., identification devices or ID devices, that communicate identification information, e.g., RSSI level, of mobile communication devices, e.g., Smart Phone 1, Smart Phone 2, or other wireless devices, for instance, between an information repository, e.g., information services about commercial participant's products and services, as disclosed in FIGS. 4 and 5 of incorporated by reference patent applications, which a summary of each of their technologies are listed below:

Application Ser. No. 13/010,437 filed on Jan. 20, 2011, discloses a wireless information communication and delivery systems are described herein that includes at least one wireless-enabled device, a device location system, a positioning and communication system, and an information repository system. A configurable wireless protocol device is disclosed that includes a multi-modal transceiver that can establish a communication network with a local wireless-enabled device. A wireless network is described that includes: at least one configurable wireless protocol device; at least one wireless-enabled device; and at least one wireless access point. Methods of locating a wireless-enabled device are described and include: providing a wireless-enabled device, providing a configurable wireless protocol device comprising a modified wireless-protocol, and utilizing the configurable wireless protocol device to actively scan for the wireless enabled device;

Application Ser. No. 13/310,761 filed on Dec. 4, 2011, discloses a method that calculates a distance to objects or a nearest object to a wireless enabled device. The method includes the steps of broadcasting a signal by the wireless enabled device to data tags, receiving by the data tags, e.g., ID tags, the signal by the wireless enabled device, and obtaining by each of the data tags, e.g., ID tags, a signal strength indicator of the wireless enabled device based on the signal from the wireless enabled device. Each of the data tags, e.g., ID tags, in a range transmits a signal to the wireless enabled device including the signal strength indicator of the wireless enabled device. Each signal strength indicator of the wireless enabled device is communicated to a positioning and communication system;

Application Ser. No. 13,349,561 filed on Jan. 13, 2012 discloses a wireless network reset system. The system couples or connects to a power supply line. A microcontroller software module senses a signal from a Wi-Fi module that indicates a halting of a processor function. A reset module executes a reset based on the halting of the processor function;

Application Ser. No. 13,349,565 filed on Jan. 13, 2012, discloses a location based system. One or more phased array modules are configured to scan to determine a signal strength indicator of a signal broadcasted from at least one wireless mobile device within a distance area. Based on a signal strength indicator measured at multiple angular directions by the one or more phased array modules from the at least one wireless mobile device, a location of each wireless mobile device is determined within a room, building, or outside location; and

Application Ser. No. 13,477,117 filed on May 22, 2012, discloses a consumer-based purchase and referral rewards loyalty system. In the system, mobile communication devices include a location tracking devices. Data tags, e.g., ID tags, or other wireless communication devices are enabled to communicate with one or more mobile communication devices and to collect an identification code of each. Custom sales presentation module communicatively couples to the mobile communication devices and the data tags, e.g., ID tags, or wireless communication devices. Responsive to a locality of goods or services proximal to or predicted proximal to the location tracking devices, the custom sales presentation module generates a user specific sales presentation, which is sent to one or more mobile communication devices to advertise products or services.

Systems 900 and 1100 disclose usage of respectively various location based systems for determining, monitoring, and managing location information between social media participants and commercial participants, e.g., commercial participants, e.g. retailers, and village network location information. Based on level of participation, e.g., licensing payments, commercial participants have different levels of access to information from a mobile communication device of social media participant including accuracy of location, profile, ability to send targeted information transfers. In one example, level one commercial participant, e.g., of BigView social media network, may have access to state of social media participant, level two commercial participant, of PreView social media network, may have access to location within a 0.5 mile range, and level three commercial participant, of InView social media network, has access to profile, e.g., user profile, so that targeted advertisements or information transfers that may directly relate to, for instance, a wish list accessible from mobile communication device of one or more social media participants and a current location, e.g., inside area within which store location, of one or more social media participants.

As such, a higher level of participation, e.g., licensing payments, commercial participants have an increasing level of confidence of the needs and wish lists of one or more social media participants. With higher level of participation, e.g., licensing payments, commercial participant obtains a scaled level of information from a mobile communication device of a social media participant, e.g., social media participant profile including likes and dislikes and items on a wish list, time in a commercial participants, store, time in front of a commercial participant store display, time viewing an item of commercial participant, where inside or outside a store a social media participant is, to provide additional insight or an ability to more fully understand desires of one social media participant and/or many social media participants, for example, included in a village network so that many social media participants may be meet at a similar time by one commercial participant.

Location based system 800, e.g., Wi-Fi device, locates wireless enabled devices, e.g., mobile communication device(s), Smart Phone(s), of social media participants that broadcast a UDP broadcast signal, e.g., Smart Phone 1, or operating in a Wi-Fi Scanning mode, e.g., Smart Phone 2, within a distance and/or distance range of objects and/or data tags, e.g., ID tags 434, 438, 442. Systems 900 and 1100 communicate, for instance, using communications server 516 by wired bus 518 or wireless means, such as Bluetooth or Wi-Fi, connectivity with private and public databases, though communications server 504, 512 having wireless capability to access, for instance, information repository 506, 508 coupled to bus 510 and extracts information. For example, information extracted includes, e.g., RSSI, from a nearby smart phone 536, for instance, Smart Phone 1 or Smart Phone 2, for example, with functionality illustrated in above incorporated by reference pending patent applications. In one variant, systems 900 and 1100 include data storage hardware device 534 capable of storage of user data, e.g., preferences, interests, “perspectives” in the information system, relative coordinates of smart phones 536, 537, 538, 539 of respective users, e.g., social media participants 201, 202, 204, 302, 304 using the smart phones 535, 536, 537, 538, 539 respectively by relative distance to consumer participant, e.g., retailer 433, 432, 440, 444, products or services or commercial participants', retailers' 433, 434, 440, 444 advertisement, as illustrated in systems 400, 500, or Wi-Fi device or data tags, e.g., ID tags 442, 434, 438 (see FIG. 4), associated with or closest to the object as illustrated in system 900.

For example, a particular item or location, e.g., as well as other information, for instance, uploads, reviews, and pictures of commercial participants products or services relative location or distance from one or more of data tags, e.g., ID tags 442, 438, 434, that are referenced, for instance, to a retailer 433, 432, 440, 444 or their information transfers respectively or other components on a temporary, transitory, or permanent basis as disclosed in the pending incorporated by reference applications. Based on level of participation and as discussed supra, commercial participants are able to view or access social media participant information accordance with level of participation, e.g., BigView commercial participants, PreView commercial participants, and InView commercial participants. Application server 502, e.g., distributed cluster of computer servers, stores executable software program code, for instance, RSSI signal strength calculation or User Datagram Protocol (UDP) algorithms in a semi-transitory or non-transitory software media capable of transferability using communications server 516 to transmit wired or wirelessly from processor unit 524. For example, processor unit 524 communicatively coupled to computer 520 has keyboard 522 to allow, for instance, a user may provide remote inputs or direct inputs, for example, when user, e.g., social media participant 201, 202, 304, 302, 304, commercial participant 444, 438, 434, 433 or representative of either, is within range, e.g., by physical location or wireless range, of keyboard 522.

As such, FIG. 4 is an exemplary system using one or more data tags, e.g., ID tags 442, 438, 434, within the area obtain the signal strength indicator, e.g., RSSI, of the at least one wireless mobile device, e.g., mobile device 536, 537, 538, 539. In one instance, advertisement module configured to direct one or more information transfers to one or more data tags, e.g., ID tags 434, 438, 442, based on a preferences list, e.g., preferences list 837 disclosed in an incorporated by reference patent applications. In one example, one or more data tags, e.g. ID tags 442, 438, 434, are associated with consumer items of a particular type or groupings in a shopping arena, e.g., 432, 440, 444 products/services center 1, 2, and 3, e.g., products-services centers 435, 437, 438. In another variant, signal strength indicator, e.g., RSSI includes a relative magnitude of a transmitted signal for each wireless mobile device within the shopping area, e.g., 432, 440, 444 products/services center 1, 2, and 3, e.g., products-services centers 435, 437, 438. On the other hand, other products/services 1, 2, 3, e.g., others products-services centers 431, 439, 441, may join one or more village network, e.g., village networks 200, 300, 400, and 500, discussed supra upon one or more conditions, e.g., obtaining appropriate licensing arrangement with the village network and/or provided an invite by a member of one or more village networks.

Based on level of participation and as discussed supra, commercial participants are able to view or access social media participant information, signal strength indicator, e.g., RSSI, in accordance with level of participation, e.g., BigView commercial participants, PreView commercial participants, and InView commercial participants.

### Content Management System Using Location Aware System

Referring to FIG. 8, a method 1300 is disclosed for communicating between commercial participants and social media participants connected by a social media network. The method includes tracking by a location-centric system store locations of its commercial participants relative to a location of one or more mobile communication device(s) of one or more portions of mobile communication devices of social media participants (step 1302). The method may further include categorizing by a product and service licensing center the commercial participants in accordance with a level of economic benefit participation in relationship to the location of one or more mobile communication device(s) of one or more portions of the social media participants (step 1304). In addition, the method may further include determining a level of economic benefit participation of its commercial participants based on a scaled commercial relationship between marketing of the commercial participants to the social media participants (step 1306).

In one alternative, a location of one or more mobile communication device(s) of one or more portions of social media participants includes a present, future, or pending location. In another alternative, tracking by a location-centric system store locations of its commercial participants relative to a location of one or more mobile communication device(s) of one or more portions of social media participants includes proximity of a portion of the commercial participants based on the scaled commercial relationship to a portion of the social media participants. In still another alternative, the scaled commercial relationship includes a personalized level of information transfers that are communicated via the social media network, the personalized level of personalized information transfers include a range from an address and phone to a personalized audio and video presentation that was generated based on a profile of likes on one or more mobile communication device(s) of one or more portions of the social media participants within a designated location or range of a commercial participants' product or service center.

In one example, the level of economic benefit participation includes whether commercial participants have or have not paid for a license to utilize a content management system (CMS). In yet another example, the method may include step of including data tags, e.g. ID tags, that are part of the location-centric system that communicate a range or level of information transfers that is comparable with a level of licensing payment.

As disclosed in the text and the figures above, CMS communicates specific content and messages to be associated with the location of a venue, either outside or inside, via a data tag, e.g., ID tag. CMS provides administrators an ability to deliver and create management communications for a mobile communication device of a social media participant. CMS also allows administrators to personalize the software application and use a social media participant's location to deliver information based on past, present, or future (predicted) location.

While the above detailed description has shown, described, and pointed out as novel features of the invention as applied to various embodiments, it will be understood that various omissions, substitutions, and changes in the form and details of the device or process illustrated may be made by those skilled in the art without departing from the invention. The foregoing description includes a best mode presently contemplated of carrying out the invention. This description is in no way meant to be limiting, but rather should be taken as illustrative of the general principles of the invention.

We claim:

1. A content management system that communicates between commercial participants and social media participants connected by a social media network comprising:
a location-centric system that tracks store locations of its commercial participants relative to a location of one or more mobile communication devices of one or more portions of social media participants;
a product and service licensing center that categorizes the commercial participants in accordance with a level of economic benefit participation in relationship to the location of the one or more mobile communication devices of the social media participants and the level of economic benefit participation provided by its commercial participants determines a scaled commercial relationship between marketing of the commercial participants to the one or more mobile communication devices of the social media participants.

2. The system of claim 1, wherein the location includes a present, future, or pending location that includes proximity of a portion of the commercial participants based on the scaled commercial relationship to a portion of the one or more mobile communication devices of the social media participants.

3. The system of claim 1, wherein the scaled commercial relationship includes a scaled level of personalized information transfers communicated via the social media network.

4. The system of claim 3, wherein the scaled level of personalized information transfers include a range from an address and phone to a personalized audio and video presentation that was generated based on a profile of likes on the one or more mobile communication devices of one or more portions of the social media participants within a designated location or range of a commercial participants' product or service center.

5. The system of claim 1, wherein the level of economic benefit participation includes whether commercial participants have or have not paid for a license to utilize the content management system.

6. The system of claim 1, wherein the location-centric system includes data tags that communicate a range or level of information transfers that is comparable with a level of licensing payment.

7. A method for communicating between commercial participants and social media participants connected by a social media network comprising:
tracking by a location-centric system store locations of its commercial participants relative to a location of one or more mobile communication devices of one or more portions of social media participants;
categorizing by a product and service licensing center the commercial participants in accordance with a level of economic benefit participation in relationship to the location of one or more mobile communication devices of the social media participants; and
determining a level of economic benefit participation of its commercial participants based on a scaled commercial relationship between marketing of the commercial participants to the one or more mobile communication devices of the social media participants.

8. The method of claim 7, wherein a location of the one or more mobile communication devices of one or more portions of social media participants includes a present, future, or pending location.

9. The method of claim 7, wherein tracking by a location-centric system store locations of its commercial participants relative to a location of the one or more mobile communication devices of one or more portions of social media participants includes a proximity of a portion of the commercial participants based on the scaled commercial relationship to the one or more mobile communication devices of a portion of the social media participants.

10. The method of claim 8, wherein the scaled commercial relationship includes a personalized level of information transfers communicated via the social media network, the personalized level of personalized information transfers include a range from an address and phone to a personalized audio and video presentation that was generated based on a profile of likes on the one or more mobile communications devices of one or more portions of the social media participants within a designated location or range of a commercial participants product or service center.

11. The method of claim 7, wherein the level of economic benefit participation includes whether commercial participants have or have not paid for a license to utilize a content management system.

12. The method of claim 7, comprising data tags that are part of the location-centric system that communicate a range or level of information transfers that is comparable with a level of licensing payment.

13. The method of claim 7, comprising information on the mobile communication device of social media participant utilized by a commercial participant to increase a level of confidence that the commercial participant providing targeted advertisement to the mobile communication device of the social media participant that meets an item liked by the social media participant.

14. The method of claim 7, comprising information on time that the mobile communication device of social media participant is located proximal to an advertisement or item of a commercial participant utilized to increase a level of confidence that commercial participant providing targeted advertisement that meets an item liked by the social media participant.

15. The method of claim 7, comprising information on future location that the mobile communication device of social media participant will be near to an advertisement or item of a commercial participant utilized to increase a level of confidence that commercial participant providing targeted advertisement that meets an item liked by the social media participant.
